(19) United States
(12) Patent Application Publication
(10) Pub. No.: US 2019/0208303 A1
(43) Pub. Date: Jul. 4, 2019

(54) EAR TIP WITH DEBRIS BARRIER FOR ACOUSTIC DEVICE

(71) Applicant: Knowles Electronics, LLC, Itasca, IL (US)

(72) Inventors: Christopher Monti, Elgin, IL (US); Shehab Albahri, Hanover Park, IL (US); Matthew Manley, Crystal Lake, IL (US); Ryan Grounds, Lake in The Hills, IL (US); Charles King, Oak Park, IL (US)

(21) Appl. No.: 16/236,381

(22) Filed: Dec. 29, 2018

Related U.S. Application Data
(60) Provisional application No. 62/612,378, filed on Dec. 30, 2017.

(51) Int. Cl. H04R 1/10

(52) U.S. Cl. CPC H04R 1/1016; H04R 1/1058

(57) ABSTRACT

An ear tip for coupling to an acoustic device includes a body member having an acoustic passage. The passage has an acoustic input and an acoustic output. An ear interface is disposed at least partially about the body member. The ear interface is formed of a resilient material and is configured to be disposed at least partially in a user's ear canal. An acoustically transmissive barrier is coupled to the body member and is disposed across the acoustic passage. In some embodiments, a grate is optionally disposed across the acoustic passage with the grate being located closer to the acoustic output than the acoustically transmissive barrier. A retention structure is disposed on a surface of the acoustic passage. The retention structure is configured to removably fasten the ear tip to the acoustic device, where sound propagates through the acoustic passage and across the acoustically transmissive barrier.

### RELATED APPLICATIONS

This application relates to U.S. Provisional Patent Application Ser. No. 62/612,378 filed on Dec. 30, 2017 and entitled “Ear Tip with Debris Barrier for Acoustic Device,” the entire contents of which is hereby incorporated by reference.

### TECHNICAL FIELD

This application relates to ear tips for acoustic devices and, more specifically to ear tips having a debris barrier.

### BACKGROUND

Acoustic devices such as headphones, hearing aids, stethoscopes and other sound emitting devices are coupled to a user's ear with an ear tip. Such ear tips typically include a sound passage with a sound inlet and a sound outlet. The sound inlet is coupled to the sound emitting device and the sound outlet is directed toward the user's ear canal in situ. However, acoustic devices are susceptible to contamination from wax and other debris that can accumulate and obstruct sound output.

### BRIEF DESCRIPTION OF THE DRAWINGS

For a more complete understanding of the disclosure, reference should be made to the following detailed description and accompanying drawings wherein:

FIG. 1 is a front perspective view of one embodiment of an ear tip;

FIG. 2 is a front view of the ear tip of FIG. 1;

FIG. 3 is a back perspective view of the ear tip of FIG. 1;

FIG. 4 is a cross-sectional view of the ear tip of FIG. 1 taken along lines A-A in FIG. 1;

FIG. 5 is a front perspective view of another embodiment of an ear tip with a grate and a ring-type carrier;

FIG. 6 is a cross-sectional view of the ear tip of FIG. 5 taken along lines B-B in FIG. 5;

FIG. 7 is a front perspective view of another embodiment of an ear tip with a front-inserted grate;

FIG. 8 is a cross-sectional view of the ear tip of FIG. 7 taken along lines C-C in FIG. 7;

FIG. 9 is a cross-sectional view of another embodiment of the ear tip of FIG. 7 with a front-inserted perforated can;

FIG. 10 is a front perspective view of another embodiment of an ear tip with a mesh; and

FIG. 11 is a cross-sectional view of the ear tip of FIG. 10 taken along lines D-D in FIG. 10.

Skilled artisans will appreciate that elements in the figures are illustrated for simplicity and clarity. It will be appreciated further that certain actions and/or steps may be described or depicted in a particular order of occurrence while those skilled in the art will understand that such order or sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

The present disclosure relates to ear tips having a debris barrier for use in combination with hearing devices. The hearing device may be embodied as a receiver-in-canal (RIC) device electrically coupled to a behind-the-ear (BTE) device. The BTE typically includes a battery and a processor and the RIC typically includes an electro-acoustic transducer disposed in a housing having a portion configured for insertion at least partially into a user's ear canal. In other embodiments, the hearing device is an in-the-ear (ITE) device or a completely-in-canal (CIC) device containing the transducer, electrical circuits and all other components. In another embodiment, the hearing device is a behind-the-ear (BTE) device containing the transducer, electrical circuits and all other components except for a sound tube that extends into the ear. The teachings of the present disclosure are also applicable to over-the-ear devices, earphones, ear buds, and ear pods, wireless (e.g., Bluetooth) headsets and in-ear devices among other wearable devices that form at least a partial seal with the user's ear and emit sound thereto.

Hearing devices typically include one or more sound-producing electro-acoustic transducers disposed in a housing that includes a spout or nozzle or some other sound emitting structure to which the ear tip is coupled. The transducer may be embodied as an armature receiver, a dynamic speaker, or some other sound-producing transducer.

The ear tip generally comprises a body member having an acoustic passage with an acoustic inlet and an acoustic outlet, and an ear interface portion disposed at least partially about the body member to form at least a partial seal with the user's ear. The acoustic inlet is coupled to a spout or nozzle of a hearing device, examples of which are described herein, and the sound outlet emits sound to the user's ear when the ear tip worn by the user. A barrier is disposed across the sound passage and is some embodiments a grate is optionally disposed between the barrier and the acoustic outlet as further described herein, along with various other optional features and exemplary implementations.

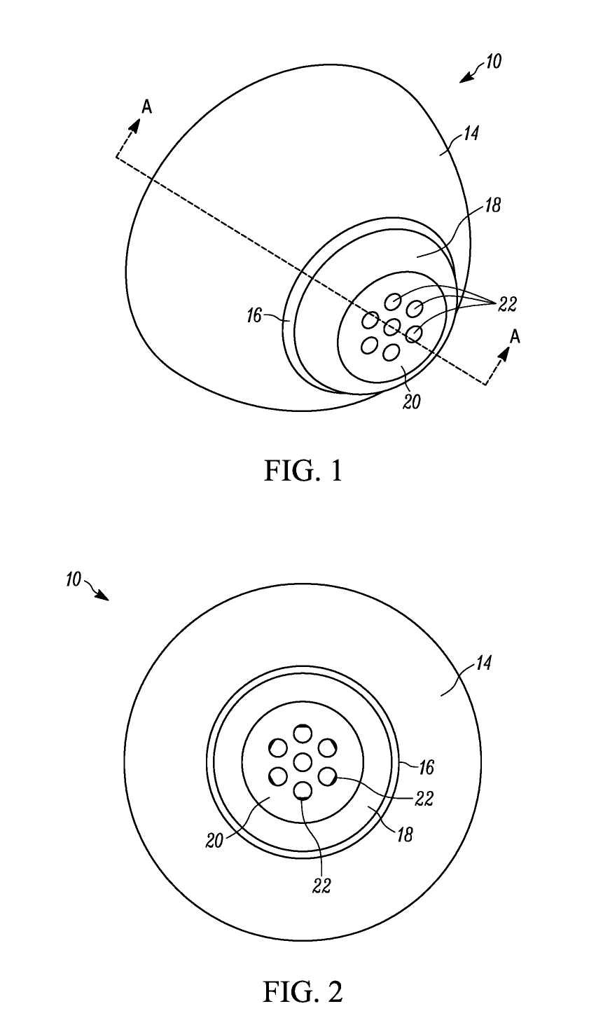

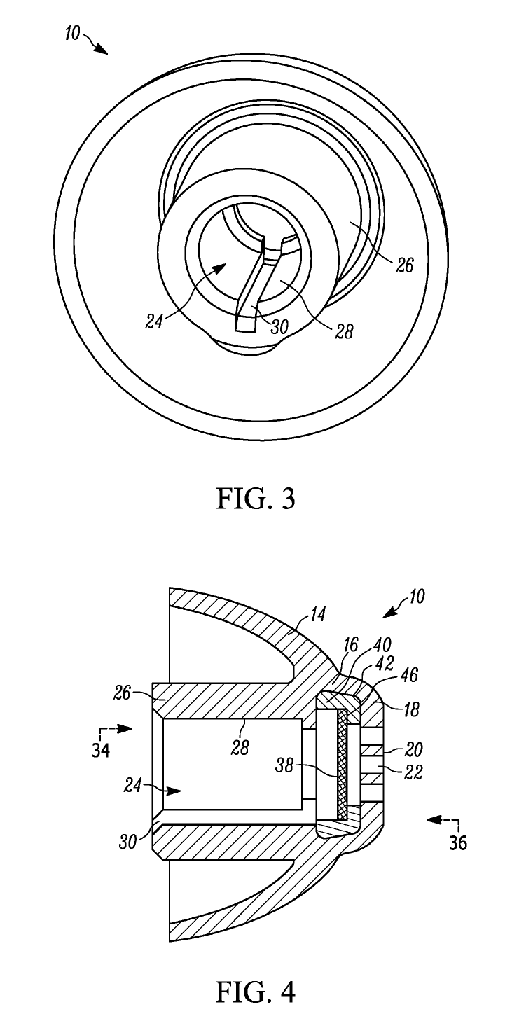

In FIGS. 1-2, an ear tip 10 is configured for removable coupling to an output of an acoustic device examples of which are discussed herein. In FIGS. 3-4, the ear tip 10 includes a body member 26 having an acoustic passage 24 through which sound passes. The acoustic passage includes an acoustic input portion or inlet 34 and an acoustic output portion or outlet 36. The ear tip includes an ear interface portion disposed at least partially about the body member. The ear interface portion forms at least a partial seal with the user's ear. In FIGS. 1-2, the ear interface portion is configured as a dome 14. In other embodiments, the ear interface portion may have other configurations, for example one or more radial fins. FIG. 2 shows the ear interface portion coupled to the body member at a transition radius 16, wherein a portion 18 of the body member protrudes beyond the radius portion. FIGS. 6, 8-9 and 11 show similar ear tips having a body member and an ear interface portion. The embodiments in FIGS. 8-9 and 11 are devoid of the transition radius 16 and protruding portion 18 shown in FIG. 4 and differ in other respects described herein.

The body member and ear interface portion may be manufactured from an elastomeric material. Suitable materials include but are not limited to natural rubber, butyl rubber or soft neoprene, polymer-based compounds like silicone, latex-based compounds and other natural or synthetic materials or combinations of such materials. The particular material used may depend on one or more factors including a desire for biocompatibility and oleophobic properties among other considerations and use case requirements. In the embodiments shown, the body member and ear interface portion constitute an unassembled unitary member that may be formed in a molding or other operation. In other embodiments however the body member and the ear interface portion constitute an assembly of separate components.

The ear tip includes an acoustically transmissive barrier coupled to the body member and disposed across the acoustic passage. Thus configured, sound propagates through the acoustic passage and across the acoustically transmissive barrier. Various structures for situating the barrier across the sound passage are described herein. The barrier may be formed of a porous material or a non-porous material. One example of a non-porous barrier material is silicone. Silicone and other non-porous materials will block more vapor phase wax migration. In one embodiment, the barrier is a mesh having a plurality of tortuous paths. Such a mesh may be made from plastic, metal, carbon fiber or some other material. The barrier may be formed of a durable material in embodiments devoid of a protection grate described further herein. Also, in some embodiments, the barrier includes an oleophobic coating.

In FIG. 4, an acoustically transmissive barrier 38 is fastened to a carrier 40 that is disposed and retained in a recess 42 of the body member. The body member 26 may be over molded about the carrier during manufacture of the body member. Alternatively, the carrier may be seated in the recess via the inlet 34 of the sound passage after formation of the body member. The carrier may be a plastic, carbon fiber, light metal or other material. The barrier may be assembled with the carrier before or after assembly of the carrier with the body member. A perimeter 46 of the barrier 38 may be fastened to the carrier 40 by an adhesive, insert molding, press-fitting, welding, staking or other fastening process or mechanism. Alternatively, the barrier and carrier may be fabricated from the same material as an unassembled unitary member. In FIG. 4, the barrier is a mesh as described herein. In other embodiments, the barrier is a porous or non-porous material.

In FIG. 6, an acoustically transmissive barrier 76 is fastened to a carrier 74 that is disposed and retained in a recess 72 of the body member. The body member may be over molded about the carrier during manufacture of the body member. Alternatively, the carrier may be seated in the recess via the inlet of the sound passage after formation of the body member. The carrier may be a plastic, carbon fiber, light metal or other material. Perimeter portions 71 and 73 of the barrier are retained in a recess of the carrier 74 by snap fit or other retention mechanism, examples of which are discussed herein. The barrier may be assembled with the carrier before or after assembly of the carrier with the body member. Alternatively, the barrier and carrier may be fabricated from the same material as an unassembled unitary member. FIG. 6, the barrier is a porous or non-porous material. In other embodiments, the barrier is a mesh.

In FIG. 8, an acoustically transmissive barrier 108 is fastened to a carrier 106 that is disposed and retained in a recess 104 of the body member. The body member may be over molded about the carrier during manufacture of the body member. Alternatively, the carrier may be seated in the recess via the sound passage after formation of the body member. In FIG. 8, a perimeter of the barrier is retained between a flange of the carrier and a retaining member 105 by snap fit or other retention mechanism, examples of which are discussed herein. The barrier 108 and the retaining member 105 may be assembled with the carrier 106 before or after the carrier is situated in the body member. The carrier and retaining member may be a plastic, carbon fiber, metal or other material. In FIG. 8, the barrier is a porous or non-porous material. In other embodiments, the barrier is a mesh.

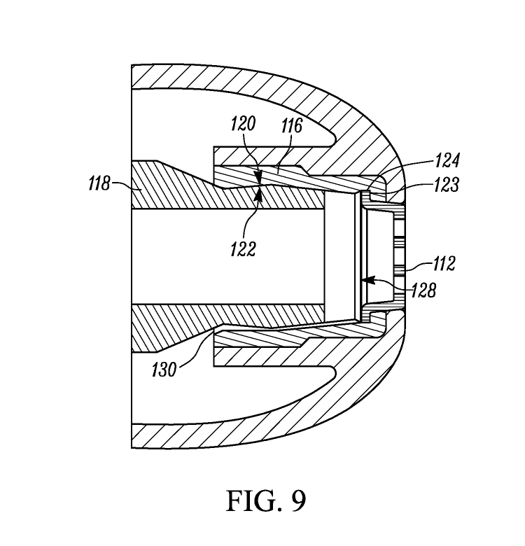

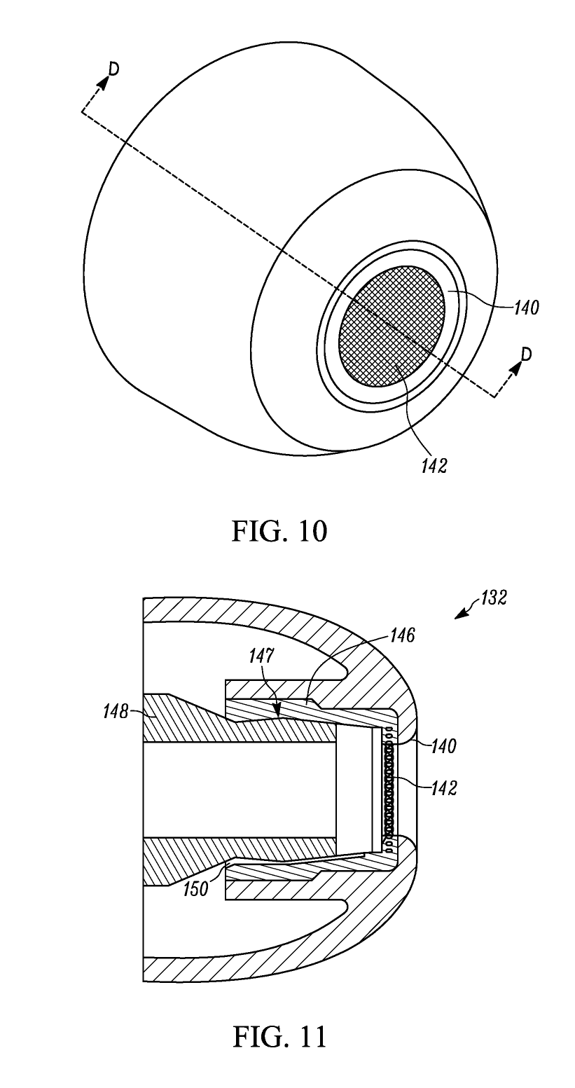

In FIG. 9, an acoustically transmissive barrier 128 is fastened to a carrier 112 embodied as a perforated can including a radial flange 123 that is disposed and retain in a recess 124 formed in a tubular sleeve 116 defining the sound passage within the body member. The body member may be over molded about the sleeve 116 during manufacture of the body member. Alternatively, the sleeve may be assembled with the body member after manufacture thereof and retain therein with adhesive or other means described herein. The carrier may be assembled with the sleeve from the inlet of the sound passage and retained therein by snap fit or other fastening means described herein. The sleeve and carrier may be formed of a plastic, carbon fiber, metal or other material. In FIG. 9, the barrier is a porous or non-porous material. In other embodiments, the barrier is a mesh.

In FIG. 11, an acoustically transmissive barrier 142 is fastened directly to an end portion of a tubular sleeve or carrier 146 defining the sound passage through the body member. The barrier can be insert-molded within the carrier during formation of the carrier. Alternatively, the barrier may be fastened to the carrier after the carrier is situated in the body member. The body member may be over molded about the carrier during manufacture of the body member. Alternatively, the carrier may be assembled with the body member after manufacture thereof and retained therein with adhesive or other fastening means described herein. In FIG. 11, the body member includes a lip 140 that extends over an end portion of the sleeve. Such a configuration helps retain the sleeve and may prevent the sleeve from dislodging into the user's ear canal. The carrier may be formed of a plastic, carbon fiber, metal or other material. In FIG. 11, the barrier is a mesh as described herein. In other embodiments, the barrier is a porous or non-porous material.

The ear tips include a retention structure formed in the sound passage for coupling with a nozzle or spout of the hearing device. Various examples of such retention structures are described herein, any one of which may be permanently or removably coupled to a hearing device.

In FIGS. 3-4, the body member 26 includes a retention structure formed on a surface 28 of the acoustic passage 24. The retention structure 26 is configured to removably fasten the ear tip 10 to an acoustic device. In FIG. 4, the sound passage of the elastic body member is configured (i.e., sized) to provide a tight friction-fit with the nozzle or output of the acoustic device without the need for friction enhancing features.

In FIG. 6, the retention structure includes recesses 66 for mating engagement with complementary barbs 68 formed on the nozzle or spout 64 of the hearing device. The retention structure of FIG. 8 shows similar recesses 96 for mating engagement with barbs 98 formed on the spout 94 of the hearing device. In alternative embodiments, the body member is devoid of recesses, wherein the elastic nature of the body member engages and retains barbs or some other structure of the nozzle or spout. In FIG. 9, the retention structure is embodied as a surface 122 on the tubular sleeve 116 situated in the body member as described herein. The engagement surface 120 is configured to engage a complementary surface 122 on the nozzle 118. In FIG. 11, the retention structure is embodied as a surface 147 on the tubular carrier 146 situated in the body member as described herein. The engagement surface 147 is configured to engage a complementary surface 140 on the nozzle 148.

In some embodiments, in addition to the acoustically transmissive barrier, the ear tip includes a grate with openings disposed across the acoustic passage. The size of the grate openings depends on the function attributable to the grate. In one example, the grate is intended to prevent ingress of debris and the openings have an average opening size greater than or equal to 50 microns. The opening size is defined as a square root of a cross-sectional area of an opening. In embodiments where the barrier is a porous material, the average opening size of the barrier is less than the average opening size of the grate. In other embodiments, the grate functions to retain other components of the ear tip, as discussed herein, and the openings may be larger. The grate may also function to protect the barrier from damage in cases where the barrier is prone to damage through physical contact with foreign objects.

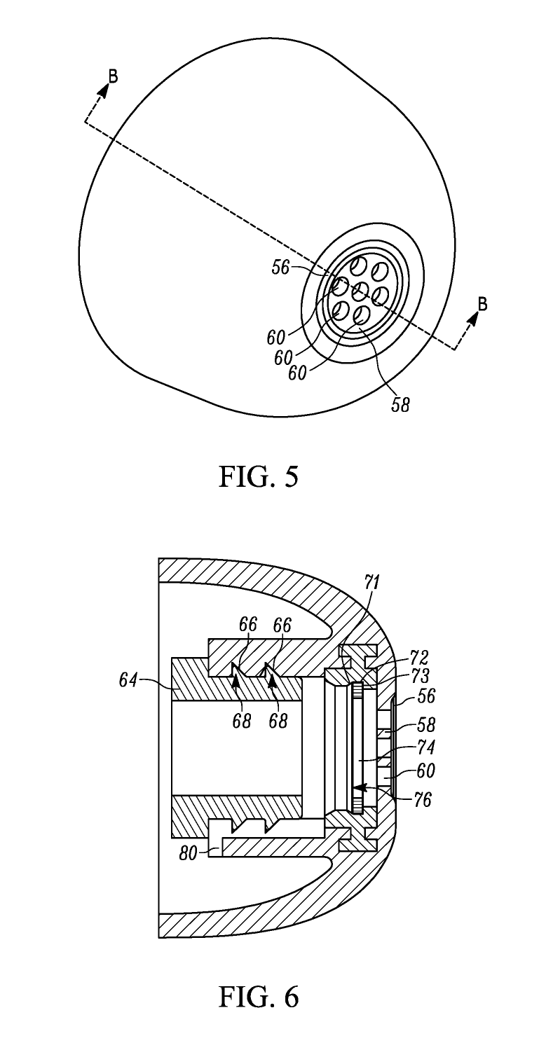

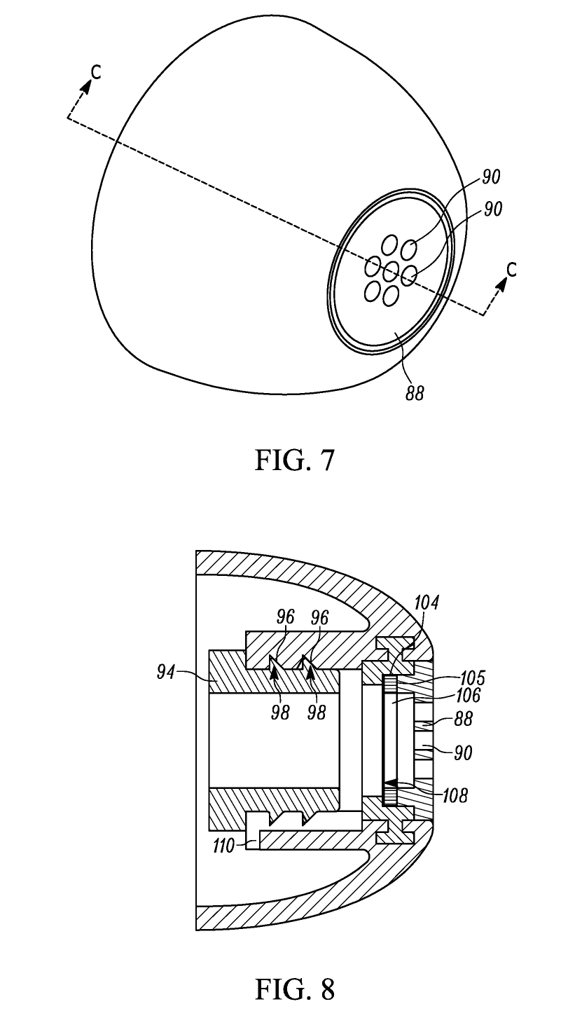

FIGS. 1-2 and 4 show a grate 20 with a plurality of openings 22. FIG. 4 shows the grate located closer to the acoustic output end portion of the acoustic passage 36 than the acoustically transmissive barrier 38. FIGS. 5-6 also show the ear tip having a grate 58 with openings 60 formed in a recessed portion 56. FIG. 6 also shows the grate located closer to the acoustic outlet 36 of the acoustic passage than the acoustically transmissive barrier. In FIGS. 1-6, the grate is an unassembled unitary part of the body member. As such the grate may be formed with the body member is a molding or other manufacturing operation. In FIGS. 7-8, the grate is a discrete component 88, having openings 90, that is assembled with the body member. The grate 88 is assembled with the carrier 106 by an adhesive or other fastening mean described herein. FIG. 9 is another embodiment where the grate is a discrete component in the form of a perforated can 112 that is fastened to the sleeve 116 as described herein. FIG. 11 does not include a grate. Alternatively, the embodiments of FIGS. 1-8 may also exclude the grate.

In some embodiments, the ear tip includes a vent to equalize air pressure in the sound passage with the ambient atmospheric pressure. Such a vent eliminates the need for a pressure equalization hole through a non-porous barrier, which is more susceptible to obstruction from wax or debris. However the vent is not required in embodiments that include a porous barrier. In FIGS. 3-4, a vent is formed by an air channel 30 disposed along the surface 28 of the acoustic passage 24. In FIG. 6, a vent is embodied as an air channel 80 formed in an inner surface of the sound passage through the body member. In FIG. 8, a vent is embodied as an air channel 110 formed in an inner surface of the sound passage through the body member. In FIG. 9, a vent is embodied as an air channel 130 formed in an inner surface of the tubular carrier member 116. In FIG. 11, a vent is embodied as an air channel 150 formed in an inner surface of the tubular carrier member 146. In all cases, one end of the vent communicates with the sound passage and another end of the vent is ported through the body member to the ambient atmosphere. The air channel or vents described are not required where the barrier is porous. In FIGS. 3-4, 9 and 11, the vent extends to an outer surface of the body member substantially parallel to an axis of the sound passage. The vents in FIGS. 6 and 8 extend to an outer surface of the body member substantially perpendicular to an axis of the sound passage.

While the present disclosure and what is presently considered to be the best mode thereof has been described in a manner that establishes possession by the inventors and that enables those of ordinary skill in the art to make and use the same, it will be understood and appreciated that there are many equivalents to the exemplary embodiments disclosed herein and that myriad modifications and variations may be made thereto without departing from the scope and spirit of the disclosure, which is to be limited not by the exemplary embodiments but by the appended claims.

1. An ear tip for removable coupling to an output of an acoustic device, the ear tip comprising:
a body member having an acoustic passage through which sound passes, the passage having an acoustic input end portion and an acoustic output end portion;
an ear interface portion disposed at least partially about the body member, the ear interface portion formed of a resilient material and configured to be disposed at least partially in a user's ear canal;
an acoustically transmissive barrier coupled to the body member and disposed across the acoustic passage;
a grate disposed across the acoustic passage, the grate located closer to the acoustic output end portion of the acoustic passage than the acoustically transmissive barrier;
a retention structure disposed on a surface of the acoustic passage, the retention structure configured to removably fasten the ear tip to the acoustic device,
wherein sound propagates through the acoustic passage, across the acoustically transmissive barrier and through the grate.

2. The ear tip of claim 1, wherein the grate has a plurality of openings with an average opening size greater than or equal to 50 microns and the barrier is a porous material having an average opening size less than the average opening size of the grate, wherein the opening size is defined as a square root of a cross-sectional area of an opening.

3. The ear tip of claim 1, wherein the grate has openings and the barrier is a non-porous material.

4. The ear tip of claim 1 further comprising a carrier retaining the barrier, wherein the carrier is coupled to the body member.

5. The ear tip of claim 4, wherein the carrier is an annular member and the body member forms at least a portion of the retention structure.

6. The ear tip of claim 4, wherein the carrier is a tubular member forming at least a portion of the retention structure.

7. The ear tip of claim 4, wherein the grate is an unassembled part of the body member.

8. The ear tip of claim 7, wherein the body member includes a recess disposed about the acoustic passage and the carrier is retained in the recess.

9. The ear tip of claim 1 further comprising an air channel in the body member, wherein the air channel equalizes air pressure in the acoustic passage with ambient atmospheric pressure and wherein the barrier is non-porous.

10. The ear tip of claim 9, wherein the air channel is disposed along a surface of the acoustic passage and extends to an outer surface of the body member.

11. An ear tip comprising:
a body member having an acoustic passage through which sound passes, the passage having an acoustic input end portion and an acoustic output end portion;
an ear interface portion disposed at least partially about the body member, the ear interface portion formed of a resilient material and configured to be disposed at least partially in a user's ear canal;
a carrier retaining a mesh, the carrier coupled by the body member with the mesh disposed across the acoustic passage;
a retention structure disposed on a surface of the acoustic passage, the retention structure configured to removably fasten the ear tip to an acoustic device,
wherein sound propagates through the acoustic passage and through the mesh.

12. The ear tip of claim 11, wherein the mesh has a plurality of openings with an average opening size less than 80 microns, wherein the opening size is defined as a square root of a cross-sectional area of an opening.

13. The ear tip of claim 11, wherein the mesh has a plurality of tortuous paths through the mesh from one side of the mesh to the other side of the mesh.

14. The ear tip of claim 13, wherein the mesh includes an oleophobic coating.

15. The ear tip of claim 11, wherein the mesh includes an oleophobic coating.

16. The ear tip of claim 11, wherein the carrier is an annular member and the body member forms at least a portion of the retention structure.

17. The ear tip of claim 16, wherein the mesh has a plurality of tortuous paths through the mesh wherein sound can propagate through the mesh via the plurality of tortuous paths.

18. The ear tip of claim 11, wherein the carrier is a tubular member forming at least a portion of the retention structure.

19. The ear tip of claim 18, wherein the mesh has a tortuous path through the mesh wherein sound can propagate through the mesh via the tortuous path.

20. The ear tip of claim 18, wherein the mesh is fastened to the carrier by any one of a friction weld, heat stake, snap fit or insert molding.
